(19) United States
(12) Patent Application Publication
(10) Pub. No.: US 2014/0375046 A1
(43) Pub. Date: Dec. 25, 2014

(54) CUSTOMIZABLE PRINT LABELS

(71) Applicant: XEROX CORPORATION, Norwalk, CT (US)

(72) Inventors: YULIN WANG, Oakville (CA); Ke Zhou, Oakville (CA); Yiliang Wu, Oakville (CA)

(73) Assignee: XEROX CORPORATION, Norwalk, CT (US)

(21) Appl. No.: 13/922,113

(22) Filed: Jun. 19, 2013

(51) Int. Cl. B42D 25/21; B42D 25/405

(52) U.S. Cl. CPC B42D 25/21; B42D 25/405
USPC 283/81; 101/450.1

(57) ABSTRACT

A customizable print label used for various identification purposes and methods for making the same. In particular, the disclosed labels are printed with inks to provide specific images or markings, such as for example, letters and/or numbers, which can be removed or otherwise altered to customize the label to a user's preference.

### BACKGROUND

The present embodiments relate to customizable print labels used for various identification purposes and methods for making the same. In particular, disclosed herein are labels that are printed with ink to provide images or markings, such as for example, letters, symbols, numbers and/or other markings, which can be removed, changed or altered into a different state to be customized to a user's preference.

There are many occasions where it would be useful to have a label for identifying various objects. For example, at a business or social gathering where drinks are served, beverage bottles are often misplaced before they are done being used. The user must consequently obtain a new bottle, which leads to unnecessary waste. In such a situation, a customizable label would be useful to help identify the bottle so that the user can readily locate the bottle.

While blank adhesive labels can be provided for a user to apply to the bottle and write his or her name or other identifying mark on the label, such labels take time to distribute, apply and write on. Users may not wish to expend the extra time or energy to do so and neglect to use such labels, even if made available. Rather, there is a need for a “smart” print label for party package supplies, such as beverage bottles, which can be manufactured along with the package and later customizable by the end user for identification purposes. In this manner, the customizable label is easy and quick to use.

### SUMMARY

According to embodiments illustrated herein, there is provided a customizable label comprising a substrate; and an image printed onto the substrate, the image further comprising one or more permanent images or markings, and one or more alterable images or markings, wherein the image can be altered from a first state to a second state.

In particular, the present embodiments provide a customizable product comprising a consumer product; and a customizable label applied to a surface of the consumer product, the customizable label comprising a substrate, and an image printed onto the substrate, the image further comprising one or more permanent images or markings, and one or more alterable images or markings, wherein the image can be altered from a first state to a second state.

In further embodiments, there is provided a method for making a customizable label comprising providing a substrate; and printing an image onto the substrate, the image further comprising one or more permanent images or markings, and one or more alterable images or markings, wherein the image can be altered from a first state to a second state.

### BRIEF DESCRIPTION OF THE DRAWINGS

For a better understanding of the present embodiments, reference may be made to the accompanying figures.

FIG. 1 is an illustration of a conventional product label;

FIG. 2A is an illustration of an customizable label made according to the present embodiments;

FIG. 2B is an illustration of the customizable label of FIG. 2A that has been personalized by an end user;

FIG. 3A is an illustration of an alternative customizable label made according to the present embodiments;

FIG. 3B is an illustration of the customizable label of FIG. 3A that has been personalized by an end user;

FIG. 3C is an illustration of the customizable label of FIG. 3A that has been personalized in an alternative manner by an end user; and

FIG. 4 is a photograph showing a customizable label made according to the present embodiments before and after personalization by a user.

### DETAILED DESCRIPTION

In the following description, it is understood that other embodiments may be utilized and structural and operational changes may be made without departure from the scope of the present embodiments disclosed herein.

The present embodiments provide a “smart” print label for party package supplies, such as beverage bottles for water, juice or other soft drinks or alcoholic beverages, that can be customized by the end user to identify the specific package. The label is easy to make, without additional cost to manufacturer, since the customizable feature is incorporated into the standard printing process used in the manufacture of the label. The resulting label is readily customized from a first state to a second state by the end user's hand, without any additional tools, and is thus easy to use.

In an embodiment, the label that conventionally is attached to a bottle can be manufactured with alterable images or markings, such as letters and/or numbers. For example, such alterable images or markings can be removable or re-writable. In embodiments, the alterable images or markings are printed on top of one or more permanent images or markings also on the label (for example, the brand name or logo for the object). In other embodiments, the alterable images or markings are printed beside the one or more permanent images or markings on the label.

In embodiments, the markings can be printed on the label with a wax-based solid ink, flexographic silver scratch-off ink, scratch-off ultraviolet (UV) flexographic ink, irreversible hydrochromic silk screen ink, photochromic ink, and the like, and mixtures thereof. In embodiments, the label comprises a substrate is selected from the group consisting of paper, plastics, ceramic, glass, metal, fabric and the like. The substrate can be printed using any number of printing methods, including but not limited to, flexographic printing, offset printing, digital printing and the like. In particular embodiments, the label can be printed with xerographic laser, flexographic, screen, gravure, or inkjet printers. In embodiments, the label is printed by at least two different printing processes, for example, a first printing process using xerographic laser printing, and the second printing process using inkjet printing. In further embodiments, the second printing is inkjet printing using a hot-melt solid ink, especially a hot-melt wax-based solid ink. The end user or customer can subsequently customize the label by personalizing the markings on the label, thus changing the label from a first state to a second state. For example, the end user or customer can scratch off certain markings, such as letters, to leave his or her initials remaining. Or alternatively, the end user or customer can scratch off the initials of his or her name. As such, the bottle can be identified as belonging to the specific end user or customer that personalized the label. With the present embodiments, there is a provided a simple and entertaining manner in which to customize the label on a product for identification purposes.

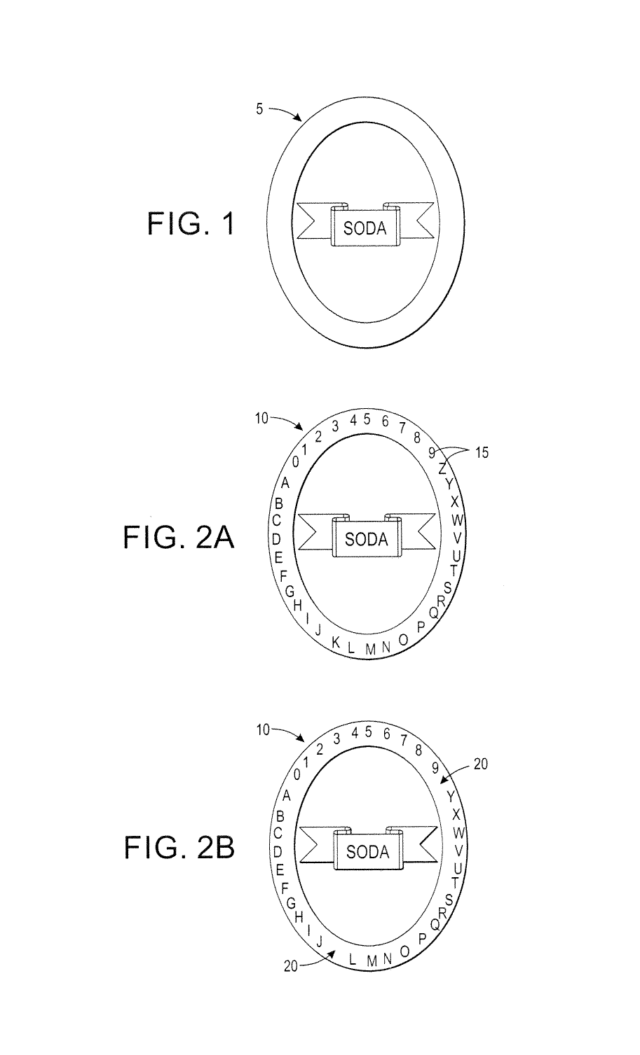

In FIG. 1, there is shown a conventional label 5 with no images or markings. FIGS. 2A-2B show an exemplary label of the present embodiments. In FIG. 2A, a customizable label 10 with removable letters and numbers 15 is shown. The customizable label can be personalized by the end user or customer in a variety of ways to help identify the bottle that he or she was drinking from. For example, the customizable label 10 can be personalized by the end user or customer by removing the letters corresponding to his or her initials 20, such as, “KZ,” on the label, as shown in FIG. 2B. In the case where more than one person has the same initials, a number can be also removed to further differentiate the label 10. The ink used to print the markings allows the markings to be easily removed by the user or customer with any hard object, such as for example, plastic blade, wood piece, coin, nail, and other hard objects. In specific embodiments, the markings are removed simply by scratching with the user or customer's finger nail. The markings can also be removed by scratching with any hard object such as a metal coin, plastic piece, and the like.

The printing of the images or markings are done during the printing of the conventional labels and using the same process printing process, thus not much additional costs are required for manufacturing these customizable labels. In addition, the customizable label uses the same conventional label material that would normally be applied to the bottle, thus there is no additional cost required for product packaging.

In one specific embodiment, the ink technology used to print the re-writable images or removable marks involves hot-melt solid ink such as wax ink or wax-based solid inks. Solid ink compositions are characterized by being solid at room temperature (e.g., 20-27° C.) and molten at an elevated temperature at which the molten ink is applied to a substrate. When printed on coated substrates or paper, as most labels are, wax ink has poor adhesion on paper. Thus, images or markings printed with such wax inks can be scratched easily off the coated substrate. Thus, such inks are suitable for the application of the present embodiments.

Any suitable hot-melt solid ink can be used. For example the hot-melt solid ink comprising polyamide and terpene resin as the binder, the hot-melt solid inks disclosed in U.S. Pat. Nos. 5,123,961, 5,221,335, 6,306,203, 6,780,900, 6,801,746, are enclosed as reference.

In another embodiment, the ink technology used to print the re-writable images or removable marks involves inks which print images that can be altered by environmental conditions, for example, thermochromatic inks. Such inks have a “trigger” temperature at a certain temperature where a property of the ink, for example, the color, image density, or gloss and the like changes. For example, in some thermochromatic inks, a trigger temperature of 88 F will cause the ink color to either disappear or change colors when the ink is rubbed, for example by the finger tips. Thus, by rubbing a customizable label printed with thermochromatic ink, the end user can personalize the label.

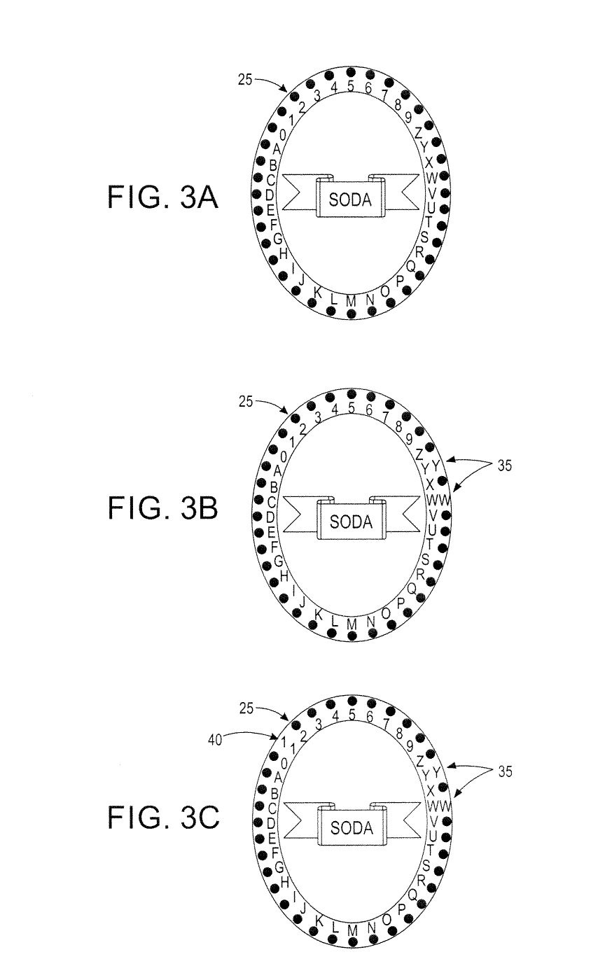

In yet another embodiment, the customizable label can be made with a removable overcoat layer. FIGS. 3A-3C show alternatives of this embodiment. In FIG. 3A, a customizable label 25 with overcoated letter and numbers 30 is shown. The overcoat layer is removable and is printed to cover some marks. Other marks or indicators can be printed beside the covered markings to indicate what marking is beneath the overcoat layer. The overcoated markings can be used to personalize the label by the end user or customer in a variety of ways to help identify the bottle that he or she was drinking from. For example, the customizable label 25 can be personalized by the end user or customer by removing the overcoated letters to reveal his or her initials 35, such as, “YW,” on the label, as shown in FIG. 3B. In the case where more than one person has the same initials, a number 40 can be removed to reveal a number to further differentiate the label 10. The ink used to print the overcoat layer allows the overcoat layer to be easily removed by the user or customer simply by scratching with his or her nail.

For a fun factor, popular cartoon characters or other images can be printed on the overcoat layer, especially for labels on children's products. Thus, the present embodiments can also be used for any product that is conventionally sold or provided to an end user with a label, including but not limited to, beverage bottles, children's toys, water bottles, soft drink package, food package, game card, disposable cup, disposable dish and the like.

One example of game card is words search game card. For example, the permanent letters for the words to be searched may be printed with a xerographic toner, while the remaining letters may be printed with alterable or removable images. Upon completion of the word searching game, one can scratch off the removable letters to reveal the answers.

In certain embodiments, the one or more permanent images or markings are printed with a xerographic toner. In certain embodiments, the one or more alterable images or markings are printed with a hot-melt solid ink.

The inks described herein are further illustrated in the following examples. All parts and percentages are by weight unless otherwise indicated.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example

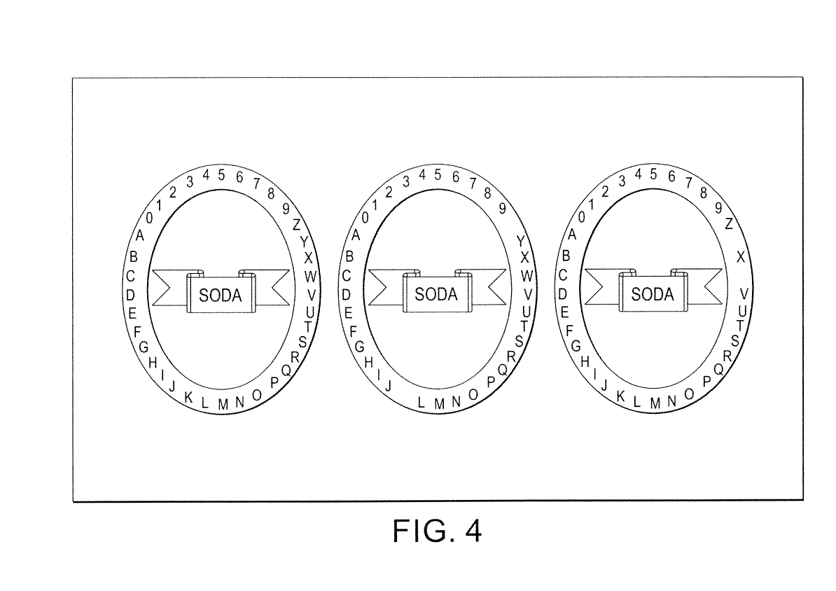

Three customizable labels with the design in FIG. 2A were printed in a row on Xerox Digital Color Elite coated paper using XEROX® ColorQube printer. This printer uses XEROX® wax solid ink, which comprises wax as the binder material. After printing, two of the three labels were customized by removing two letters in each label using a coin or a nail. The desired letters could be removed easily. FIG. 4 shows photos of the original label (far left) and two customized labels (middle and far right) with letters “KZ” and “YW” removed.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

What is claimed is:

1. A customizable label comprising:
a substrate; and
an image printed onto the substrate, the image further comprising one or more permanent images or markings, and
one or more alterable images or markings, wherein the image can be altered from a first state to a second state.

2. The customizable label of claim 1, wherein one or more alterable images or markings are printed with an ink selected from the group consisting of a hot- melt solid ink, flexographic silver scratch-off ink, scratch-off ultraviolet (UV) flexographic ink, irreversible hydrochromic silk screen ink, photochromic ink, and mixtures thereof.

3. The customizable label of claim 1, wherein the substrate is selected from the group consisting of paper, plastics, ceramic, glass, metal, fabric and mixtures thereof.

4. The customizable label of claim 1 being changed from the first state to the second state by removing one or more of the alterable images or markings from the image.

5. The customizable label of claim 1, wherein the one or more alterable images or markings is printed on top of the one or more permanent images or markings.

6. The customizable label of claim 1, wherein the one or more alterable images or markings is printed beside the one or more permanent images or markings.

7. The customizable label of claim 1 being changed from the first state to the second state by altering a property of one or more of the alterable images or markings.

8. The customizable label of claim 7, wherein the altered property is selected from the group consisting of color, image density, gloss, and mixtures thereof.

9. A customizable product comprising:
a consumer product; and
a customizable label applied to a surface of the consumer product, the customizable label comprising
a substrate, and
an image printed onto the substrate, the image further comprising
one or more permanent images or markings, and
one or more alterable images or markings, wherein the image can be altered from a first state to a second state.

10. The customizable product of claim 9, wherein the consumer product is selected from the group consisting of beverage bottles, children's toys, water bottles, soft drink package, food package, disposable cup, and disposable dish.

11. The customizable label of claim 9, wherein the one or more alterable images or markings is printed on top of the one or more permanent images or markings.

12. The customizable label of claim 9, wherein the one or more alterable images or markings is printed beside the one or more permanent images or markings.

13. The customizable label of claim 1, wherein the one or more alterable images or markings is printed with a hot-melt solid ink.

14. A method for making a customizable label comprising providing a substrate; and
printing an image onto the substrate, the image further comprising one or more permanent images or markings, and
one or more alterable images or markings, wherein the image can be altered from a first state to a second state.

15. The method of claim 14, wherein the printing step is performed by flexographic printing, offset printing, and digital printing.

16. The method of claim 14, wherein the one or more alterable images or markings are printed with an ink selected from the group consisting of a hot-melt solid ink, flexographic silver scratch-off ink, scratch-off ultraviolet (UV) flexographic ink, irreversible hydrochromic silk screen ink, photochromic ink, and mixtures thereof.

17. The method of claim 14, wherein the substrate is selected from the group consisting of paper, plastics, ceramic, glass, metal, fabric and mixtures thereof.

18. The method of claim 14, wherein customizable label is changed from the first state to the second state by removing one or more of the alterable images or markings from the image.

19. The method of claim 14, wherein the one or more alterable images or markings are printed with a hot-melt solid ink.

20. The method of claim 14, wherein the one or more permanent images or markings are printed with a xerographic toner and the one or more alterable images or markings are printed with a hot-melt solid ink.
